(19) United States
(12) Patent Application Publication
(10) Pub. No.: US 2002/0080878 A1
(43) Pub. Date: Jun. 27, 2002

(54) Video apparatus and method for digital video enhancement

(75) Inventor: Weiping Li, Palo Alto, CA (US)

Correspondence Address: Martin Novack, 17414 Via Capri East, Boca Raton, FL, 33496, US

(73) Assignee: WebCast Technologies, Inc.

(21) Appl. No.: 09/977,081

(22) Filed: Oct. 12, 2001

Related U.S. Application Data
(60) Provisional application No. 60/239,676, filed on Oct. 12, 2000.

(51) Int. Cl. H04N 7/12

(52) U.S. Cl. 375/240.11; 382/240; 375/240.08

(57) ABSTRACT

A method for encoding frames of input video, including the following steps: processing the input video to produce a compressed base layer bitstream; processing the input video to produce a compressed enhancement layer bitstream; identifying a region of interest in a video frame; and enhancing the quality of the region of interest by providing additional bits for coding said region.

### RELATED APPLICATION

Priority is claimed from U.S. Provisional Patent Application No. 60/239,676, filed Oct. 12, 2000, and said Provisional Patent Application is incorporated herein by reference.

### FIELD OF THE INVENTION

This invention relates to digital video and, more particularly, to a method and apparatus for region of interest enhancement of digital video.

### BACKGROUND OF THE INVENTION

In many application s of digital video, compression needs to be used due to the limited bandwidth for transmission or the limited capacity for storage. Video compression reduces the amount of bits for representing a video signal at the expense of video quality. Higher compression results in greater quality loss. In some applications, the quality requirement for a region of interest of a given frame is different from that for other parts of the same frame. For example, in video surveillance, a moving object requires a higher quality than the background. Therefore, to achieve the highest possible compression and the highest possible quality for a given region of interest, it would be desirable to have a method and apparatus to automatically identify the region of interest and code it at a higher quality than the rest of the frame. It is among the objects of the present invention to devise such a method and apparatus.

### SUMMARY OF THE INVENTION

In accordance with an embodiment of the invention, there is set forth a method for encoding frames of input video, comprising the following steps: processing the input video to produce a compressed base layer bitstream; processing the input video to produce a compressed enhancement layer bitstream; identifying a region of interest in a video frame; and enhancing the quality of the region of interest by providing additional bits for coding said region.

Further features and advantages of this invention will become more readily apparent from the following detailed description when taken in conjunction with the accompanying drawings.

### BRIEF DESCRIPTION OF THE DRAWINGS

FIG. 1 is block diagram of an embodiment of an encoder employing scalable coding technology.

FIG. 2 is a block diagram of an embodiment of a decoder.

### DETAILED DESCRIPTION

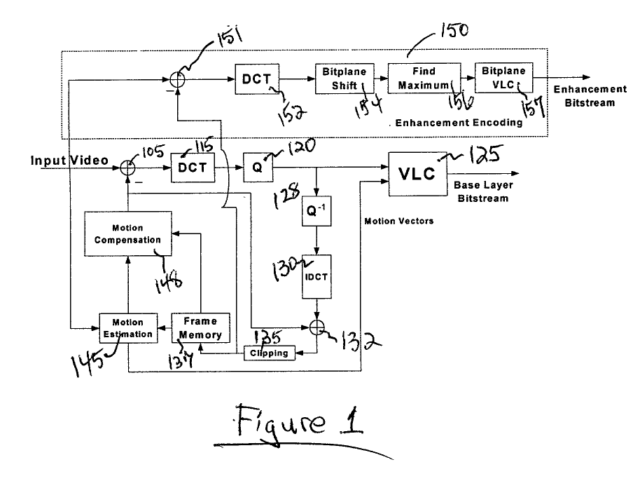

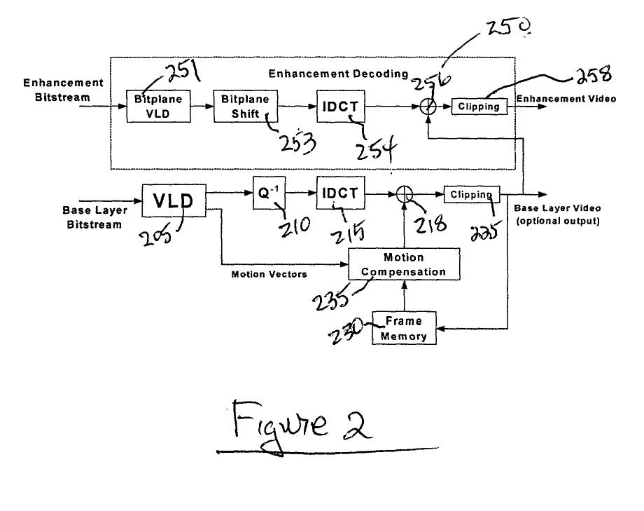

MPEG-4 scalable coding technology employs bitplane coding of discrete cosine transform (DCT) coefficients. FIGS. 1 and 2 show, respectively, encoder and decoder structures employing scalable coding technology. The lower parts of FIGS. 1 and 2 show the base layer and the upper parts in the dotted boxes 150 and 250, respectively, show the enhancement layer. In the base layer, motion compensated DCT coding is used.

In FIG. 1, input video is one input to combiner 105, the output of which is coupled to DCT encoder 115 and then to quantizer 120. The output of quantizer 120 is one input to variable length coder 125. The output of quantizer 120 is also coupled to inverse quantizer 128 and then inverse DCT 130. The IDCT output is one input to combiner 132, the output of which is coupled to clipping circuit 135. The output of the clipping circuit is coupled to a frame memory 137, whose output is, in turn, coupled to both a motion estimation circuit 145 and a motion compensation circuit 148. The output of motion compensation circuit 148 is coupled to negative input of combiner 105 (which serves as a difference circuit) and also to the other input to combiner 132. The motion estimation circuit 145 receives, as its other input, the input video, and also provides its output to the variable length coder 125. In operation, motion estimation is applied to find the motion vector(s) (input to the VLC 125) of a macroblock in the current frame relative to the previous frame. A motion compensated difference is generated by subtracting the current macroblock from the best-matched macroblock in the previous frame. Such a difference is then coded by taking the DCT of the difference, quantizing the DCT coefficients, and variable length coding the quantized DCT coefficients. In the enhancement layer 150, a difference between the original frame and the reconstructed frame is generated first, by difference circuit 151. DCT (152) is applied to the difference frame and bitplane coding of the DCT coefficients is used to produce the enhancement layer bitstream. This process includes a bitplane shift (block 154), determination of a maximum (block 156) and bitplane variable length coding (block 157). The output of the enhancement encoder is the enhancement bitstream.

In the decoder of FIG. 2, the base layer bitstream is coupled to variable length decoder 205, the outputs of which are coupled to both inverse quantizer 210 and motion compensation circuit 235 (which receives the motion vectors portion fo the VLSD output). The output of inverse quantizer 210 is coupled to inverse DCT circuit 215, whose output is, in turn, an input to combiner 218. The other input to combiner 218 is the output of motion compensation circuit 235. The output of combiner 218 is coupled to clipping circuit 225 whose output is the base layer video and is also coupled to frame memory 230. The frame memory output is input to the motion compensation circuit 235. In the enhancement decoder 250, the enhancement bitstream is coupled to variable length decoder 251, whose output is coupled to bitplane shifter 253 and then inverse DCT 254. The output of IDCT 254 is one input to combiner 256, the other input to which is the decoded base layer video (which, of itself, can be an optional output). The output of combiner 256 is coupled to clipping circuit, whose output is the decoded enhancement video.

To automatically identify a region of interest in a video frame, several criteria can be used. One of these is based on the magnitude of the motion vectors. Motion estimation is used to find the best-matched location in the search range of the previous frame for each macroblock (16×16 pixels) in the current frame. The relative displacements in the horizontal and vertical directions form a motion vector for the macroblock. A larger magnitude for the motion vector means that the macroblock is associated with a faster motion object. If any moving objects are to be coded at a higher quality than the background, such a macroblock is to be coded at a higher quality. Another criterion is based on the local activity. For a macroblock associated with high local activities, the motion vector is not large and the motion compensated difference is large. Such a macroblock is coded in the intra-mode, meaning that the current macroblock is coded as it is without motion compensation. If high local activity is of interest, the intra-mode macroblocks in the motion compensated frames should be enhanced better than the rest of the frame. Yet another criterion is based on the intensity change of a macroblock relative to the neighboring macroblocks. Such an intensity change can also be coupled with the motion vectors. For example, if a part of a moving object is of interest, such a macroblock should be coded of higher quality.

After identifying the region of interest in a frame, the next question is how to have higher quality for that region relative to the other parts of the frame. To ensure a higher quality for the identified region of interest, the quantization step-size in the base-layer and the bit-shifting in the enhancement layer are controlled. The quality of a macroblock depends on how much quantization is done in the base layer and how many bitplanes are received in the enhancement layer. Therefore, for a macroblock associated with an identified region of interest, we use a smaller quantization step-size in the base layer. Also, we use the selective enhancement feature of the enhancement layer and assign higher bit-shifting values to such a macroblock in the enhancement layer. The result is that, if only the base layer is transmitted, the identified region of interest has a higher quality than the rest of the frame. If a part of the enhancement layer bitstream is received, more bitplanes associated with the identified region of interest are received relative to the rest of the frame and the quality is much enhanced.

1. A method for encoding frames of input video, comprising the steps of:
processing said input video to produce a compressed base layer bitstream;
processing said input video to produce a compressed enhancement layer bitstream;
identifying a region of interest in a video frame; and
enhancing the quality of the region of interest by providing additional bits for coding said region.

2. The method as defined by claim 1, wherein said step of providing additional bits for coding said region comprises providing additional bits for said region in the compressed base layer bitstream.

3. The method as defined by claim 1, wherein said step of providing additional bits for coding said region comprises providing additional bits for said region in the compressed enhancement layer bitstream.

4. The method as defined by claim 2, wherein said processing to produce a compressed base layer bitstream includes a quantization step, and wherein said step of providing additional bits for said region includes decreasing the quantization step in said region.

5. The method as defined by claim 3, wherein said processing to produce a compressed enhancement layer bitstream includes a bit plane shifting step, and wherein said step of providing additional bits for said region includes increasing the bit shifting values in said region.

6. The method as defined by claim 1, wherein said step of processing said input video to produce a compressed base layer bitstream includes forming motion vectors, and wherein said step of identifying a region of interest in a video frame includes basing said identifying on said motion vectors.

7. The method as defined by claim 3, wherein said step of processing said input video to produce a compressed base layer bitstream includes forming motion vectors, and wherein said step of identifying a region of interest in a video frame includes basing said identifying on said motion vectors.

8. The method as defined by claim 4, wherein said step of processing said input video to produce a compressed base layer bitstream includes forming motion vectors, and wherein said step of identifying a region of interest in a video frame includes basing said identifying on said motion vectors.

9. The method as defined by claim 6, wherein said step of identifying a region of interest in a video frame based on said motion vectors includes basing said identification on the magnitude of motion vectors.

10. The method as defined by claim 6, wherein said step of identifying a region of interest in a video frame based on said motion vectors includes basing said identification on the intensity change of neighboring regions based on motion vectors.

11. The method as defined by claim 3, wherein said step of processing said input video to produce a compressed base layer bitstream includes forming motion vectors and determining motion compensation values, and wherein said step of identifying a region of interest in a video frame includes basing said identifying on said motion vectors and said motion compensation values.

12. The method as defined by claim 4, wherein said step of processing said input video to produce a compressed base layer bitstream includes forming motion vectors and determining motion compensation values, and wherein said step of identifying a region of interest in a video frame includes basing said identifying on said motion vectors and said motion compensation values.
